(19) United States
(12) Patent Application Publication
(10) Pub. No.: US 2020/0200667 A1
(43) Pub. Date: Jun. 25, 2020

(54) PARTICLE DETECTION ELEMENT AND PARTICLE DETECTOR

(71) Applicant: NGK INSULATORS, LTD., Nagoya-City (JP)

(72) Inventors: Keiichi Kanno, Nagoya-City (JP); Hidemasa Okumura, Nagoya-City (JP); Kazuyuki Mizuno, Nagoya-City (JP)

(73) Assignee: NGK INSULATORS, LTD., Nagoya-City (JP)

(21) Appl. No.: 16/804,525

(22) Filed: Feb. 28, 2020

Related U.S. Application Data
(63) Continuation of application No. PCT/JP2017/032103, filed on Sep. 6, 2017.

(51) Int. Cl. G01N 15/06

(52) U.S. Cl. CPC G01N 15/0656

(57) ABSTRACT

A particle detection element used to detect particles in gas, the particle detection element includes a housing having a gas flow passage through which the gas passes, wherein the gas flow passage is a rectangular-cuboid-shaped space that extends continuously from a gas inlet having a rectangular shape to a gas outlet having same shape as the shape of the gas inlet, and when the particle detection element is disposed in the flow of the gas so that the gas passes through the gas flow passage, a low-flow-velocity region in which the gas flows at a flow velocity lower than a flow velocity at which the gas passes through the gas flow passage is generated in a region downstream of the gas outlet.

### BACKGROUND OF THE INVENTION

### 1. Field of the Invention

The present invention relates to a particle detection element and a particle detector.

### 2. Description of the Related Art

An example of a known particle detector generates ions due to a corona discharge with an electric-charge-generating element, so that particles in measurement target gas are charged due to the ions and changed into charged particles. The charged particles are collected by a collecting electrode, and the number of particles is determined based on the amount of electric charges on the charged particles that are collected (see, for example, PTL 1).

### CITATION LIST

### Patent Literature

PTL 1: International Publication No. 2015/146456 pamphlet

### SUMMARY OF THE INVENTION

However, according to PTL 1, not all of the charged particles can be collected by the collecting electrode, and some of the charged particles are discharged out of the particle detector. Accordingly, the collection rate at which the collecting electrode collects the charged particles is desirably increased.

The present invention has been made to solve the above-described problem, and the main object of the present invention is to increase the collection rate at which the collecting electrode collects the charged particles.

To achieve the above-described main object, the present invention employs the following configurations.

A particle detection element according to the present invention is used to detect particles in gas, and includes a housing having a gas flow passage through which the gas passes; an electric-charge-generating unit that supplies electric charges generated due to a discharge to the particles in the gas introduced into the housing, thereby changing the particles into charged particles; and a collecting electrode disposed in the housing at a location downstream of the electric-charge-generating unit along a flow of the gas, the collecting electrode collecting the charged particles. The gas flow passage is a rectangular-cuboid-shaped space that extends continuously from a gas inlet having a rectangular shape to a gas outlet having same shape as the shape of the gas inlet. When the particle detection element is disposed in the flow of the gas so that the gas passes through the gas flow passage, a low-flow-velocity region in which the gas flows at a flow velocity lower than a flow velocity at which the gas passes through the gas flow passage is generated in a region downstream of the gas outlet.

According to this particle detection element, the electric-charge-generating unit generates electric charges so that the particles in the gas are changed into charged particles, and the collecting electrode collects the charged particles. The collecting electrode causes a change in a physical quantity depending on the number of charged particles collected by the collecting electrode. Therefore, the number of particles in the gas can be determined by using the particle detection element. The gas flow passage is the rectangular-cuboid-shaped space that extends continuously from the gas inlet having a rectangular shape to the gas outlet having the same shape as the shape of the gas inlet. When the particle detection element is disposed in the flow of the gas so that the gas passes through the gas flow passage, the low-flow-velocity region in which the gas flows at the flow velocity lower than the flow velocity at which the gas passes through the gas flow passage is generated in the region downstream of the gas outlet. The charged particles that have not been collected by the collecting electrode flow out of the gas outlet and reach the low-flow-velocity region. The charged particles that have reached the low-flow-velocity region serve to push back the subsequent charged particles toward the gas flow passage by electric repulsive force when the subsequent charged particles are not collected by the collecting electrode and flow out of the gas outlet. As a result, the collection rate at which the collecting electrode collects the charged particles is increased.

In this specification, the term “particle detection element” refers to an element that determines the amount of particles (for example, the number, mass, surface area, etc., of particles).

In the particle detection element according to the present invention, (flow velocity of the gas in the low-flow-velocity region)/(maximum flow velocity of the gas that passes through the gas flow passage)≤0.57 may be satisfied. In such a case, the effect of the present invention can be enhanced.

In the particle detection element according to the present invention, the low-flow-velocity region is formed to cover the gas outlet. In such a case, the effect of the present invention can be enhanced.

In the particle detection element according to the present invention, the housing may include a pair of flow passage walls that define the gas flow passage, and when a distance between the pair of flow passage walls is defined as a flow passage width of the gas flow passage, (wall thickness of the flow passage walls)/(flow passage width)≤0.65 may be satisfied. In such a case, the low-flow-velocity region is reliably formed to cover the gas outlet, and (flow velocity of the gas in the low-flow-velocity region)/(maximum flow velocity of the gas that passes through the gas flow passage)≤0.31 is satisfied. Accordingly, the effect of the present invention can be enhanced.

In the particle detection element according to the present invention, a corner including a side of the housing that is positioned around the gas inlet may have a radius of curvature of 1.0 mm or less (in particular, 0.3 mm or less). In this case, the gas that has not entered the gas flow passage through the gas inlet comes into contact with the corner, and then flows at a low velocity in a region closer to the housing than is a separation surface, which extends obliquely rearward from an outer surface of the housing, and at a high velocity in a region farther from the housing than is the separation surface. It is generally known that the efficiency of heat exchange between low-velocity gas and a solid is lower than the efficiency of heat exchange between high-velocity gas and a solid. Therefore, the heat exchange between the housing and the gas is reduced, and a temperature change in the housing is reduced accordingly. The above-described structure is significantly advantageous when (wall thickness of the flow passage walls)/(flow passage width)≤0.65 is satisfied. This is because, in this case, the flow passage walls have a small heat capacity and are therefore easily affected by the heat exchange with the gas.

In the particle detection element according to the present invention, the housing may be an elongated body that extends in a longitudinal direction that crosses an axial direction of the gas flow passage, one end of the elongated body in the longitudinal direction having the gas flow passage and being disposed in a pipe through which the gas flows, other end of the elongated body in the longitudinal direction having at least a terminal of the electric-charge-generating unit and a terminal of the collecting electrode and being disposed outside the pipe. In this case, the terminal of the electric-charge-generating unit and the terminal of the collecting electrode are not easily affected by the high-temperature gas that flows through the pipe, and can be connected to wires with a joining material having a relatively low heat resistance, such as solder.

A particle detector according to the present invention includes the particle detection element of any one of the above-described embodiments and a detection unit that detects the particles based on a physical quantity that varies depending on the charged particles collected by the collecting electrode. Therefore, the particle detector has an effect similar to the effect of the above-described particle detection element according to the present invention. For example, the collection rate at which the collecting electrode collects the charged particles is increased.

In this specification, the term “electric charges” includes positive and negative electric charges, and also include ions. The expression “detect particles” includes not only a case in which the amount of particles (for example, the number, mass, and surface area of the particles) is determined but also a case in which it is determined whether or not the amount of particles is within a predetermined numerical range (for example, whether or not the amount of particles is greater than a predetermined threshold). The term “physical quantity” refers to any parameter that varies depending on the number of charged particles (amount of electric charges), and may be, for example, a current.

### BRIEF DESCRIPTION OF THE DRAWINGS

FIG. 1 illustrates a particle detector 10.

FIG. 2 is a perspective view of a particle detection element 20.

FIG. 3 is a partial enlarged view of FIG. 2.

FIG. 4 is a sectional view of FIG. 2 taken along line A-A.

FIG. 5 is a sectional view of FIG. 2 taken along line B-B.

FIG. 6 is an exploded perspective view of the particle detection element 20.

FIG. 7 illustrates a flow velocity distribution of gas that flows inside and outside the particle detection element 20.

FIG. 8 illustrates a flow velocity distribution of gas that flows inside and outside the particle detection element 20.

### DETAILED DESCRIPTION OF THE INVENTION

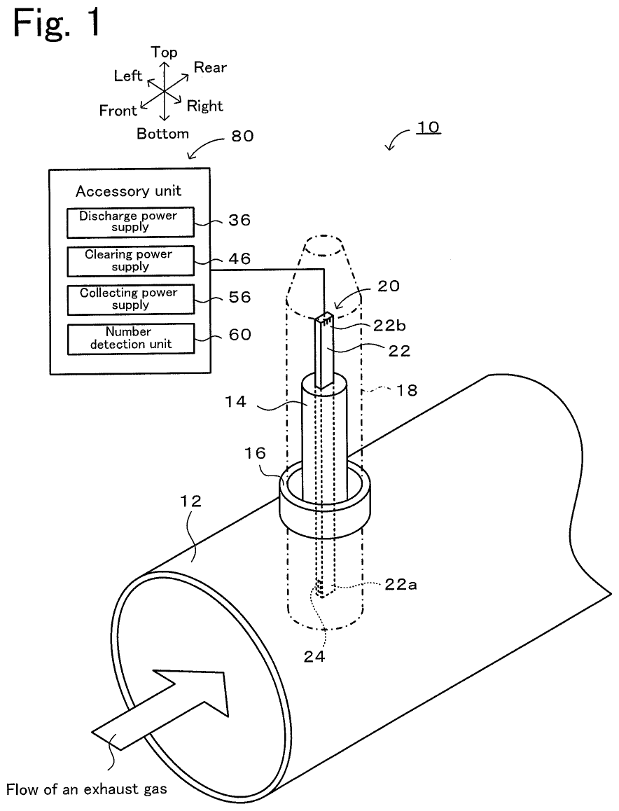

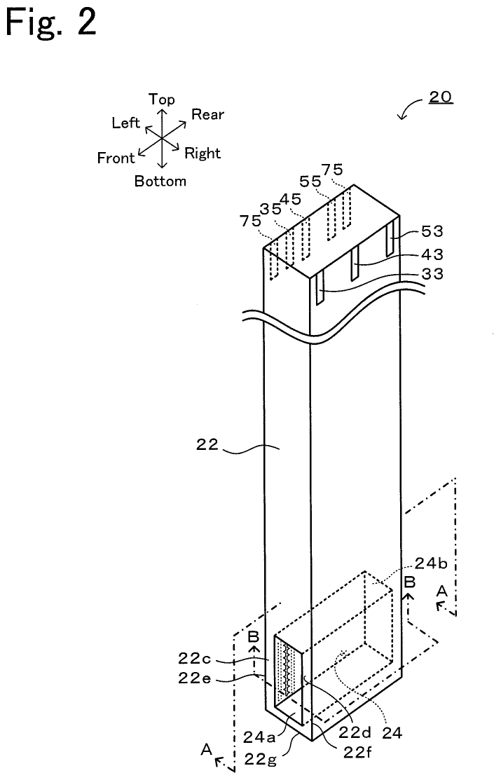

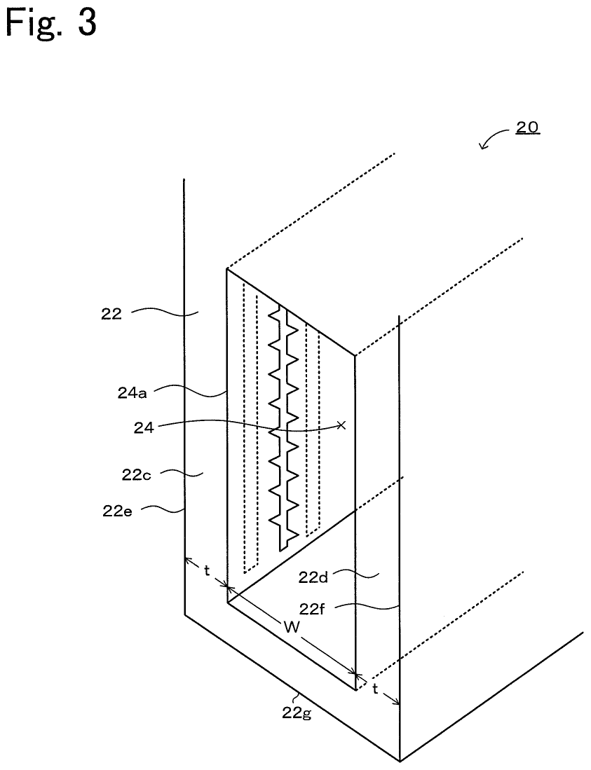

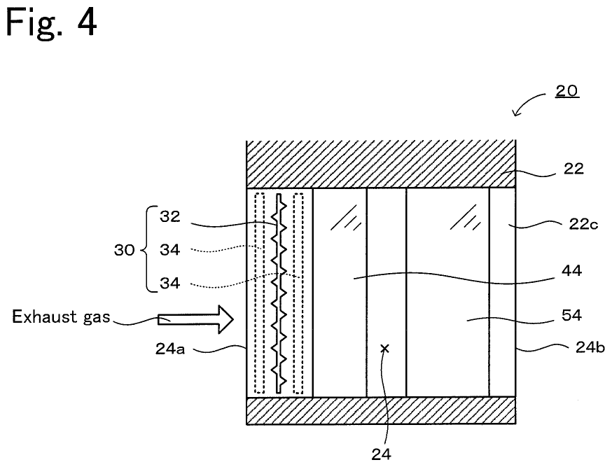

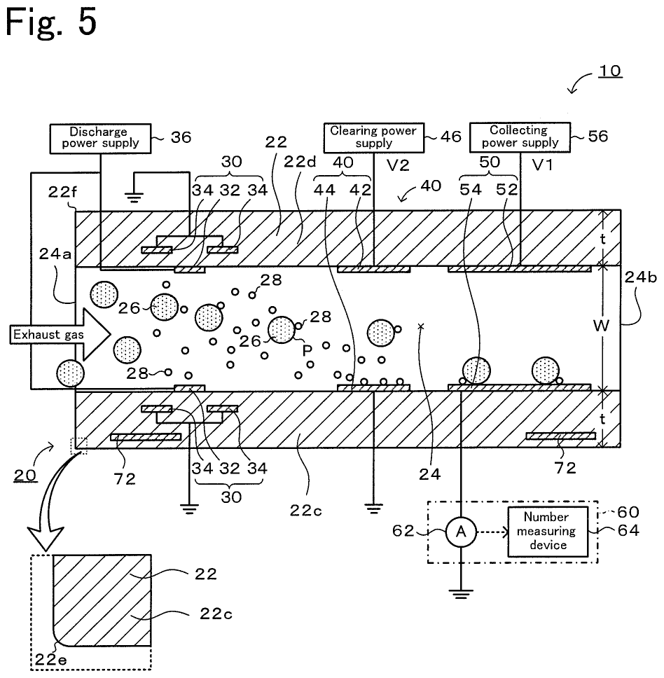

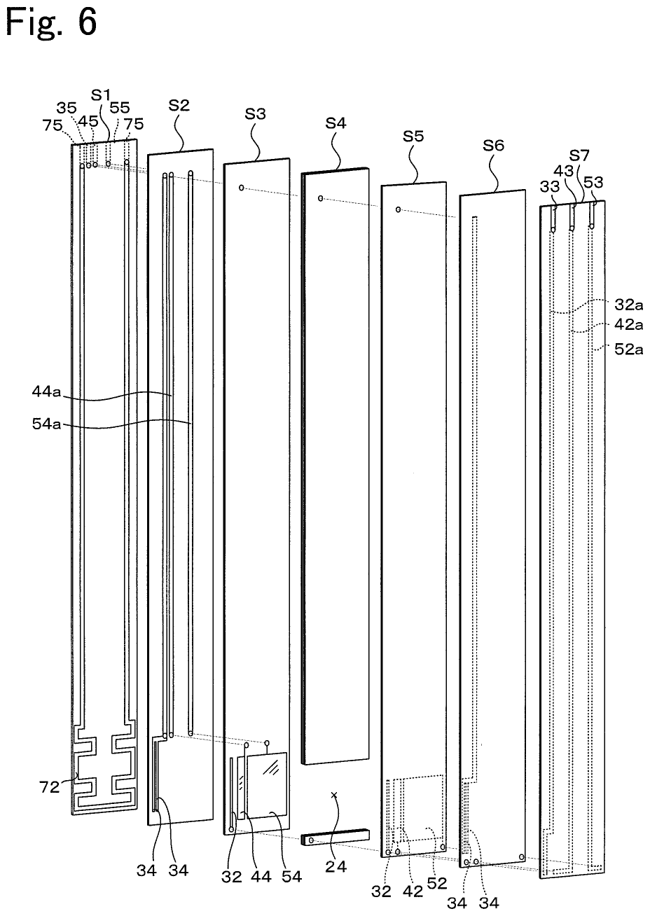

An embodiment of the present invention will now be described with reference to the drawings. FIG. 1 illustrates a particle detector 10 according to an embodiment of the present invention. FIG. 2 is a perspective view of a particle detection element 20. FIG. 3 is a partial enlarged view of FIG. 2. FIG. 4 is a sectional view of FIG. 2 taken along line A-A. FIG. 5 is a sectional view of FIG. 2 taken along line B-B. FIG. 6 is an exploded perspective view of the particle detection element 20. In the present embodiment, the up-down direction, the left-right direction, and the front-back direction are as illustrated in FIGS. 1 and 2.

Referring to FIG. 1, the particle detector 10 determines the number of particles 26 (see FIG. 5) contained in exhaust gas that flows through an exhaust pipe 12 of an engine. This particle detector 10 includes the particle detection element 20 and an accessory unit 80 including various power supplies 36, 46, and 56 and a number detection unit 60.

As illustrated in FIG. 1, the particle detection element 20 is inserted in a cylindrical support body 14 and attached to a ring-shaped base 16 fixed to the exhaust pipe 12. The particle detection element 20 is protected by a protective cover 18. The protective cover 18 has a hole (not shown), and exhaust gas that flows through the exhaust pipe 12 passes through this hole and through a gas flow passage 24 provided at a bottom end of the particle detection element 20. As illustrated in FIG. 5, the particle detection element 20 includes electric-charge-generating units 30, an excess-electric-charge-removing unit 40, a collecting unit 50, and a heater electrode 72, which are disposed in a housing 22.

As illustrated in FIG. 1, the housing 22 has an elongated rectangular-cuboid-shaped body that extends in a direction that crosses an axial direction of the exhaust pipe 12 (in this example, in a direction substantially orthogonal to the axial direction of the exhaust pipe 12). The housing 22 is an insulator and is made of, for example, a ceramic such as alumina. The housing 22 has a bottom end 22a disposed in the exhaust pipe 12 and a top end 22b disposed outside the exhaust pipe 12. The housing 22 is provided with the gas flow passage 24 at the bottom end 22a thereof. The housing 22 is provided with various terminals at the top end 22b thereof.

An axial direction of the gas flow passage 24 is the same as the axial direction of the exhaust pipe 12. As illustrated in FIG. 2, the gas flow passage 24 is a rectangular-cuboid-shaped space that extends continuously from a rectangular gas inlet 24a provided in a front surface of the housing 22 to a rectangular gas outlet 24b provided in a rear surface of the housing 22. The housing 22 includes a pair of left and right flow passage walls 22c and 22d that define the gas flow passage 24 (see FIGS. 2 and 3). In the present embodiment, as illustrated in FIG. 3, the distance between the pair of left and right flow passage walls 22c and 22d is referred to as a flow passage width W of the gas flow passage 24. The flow passage walls 22c and 22d may have a wall thickness t that is either greater or less than the flow passage width W, but is preferably less than the flow passage width W, and t/W≤0.65 is preferably satisfied. In addition, 0.17≤t/W is preferably satisfied. For example, preferably, the flow passage width W is set to a certain value in the range of 1 to 5 mm, and the wall thickness t is set so that the above inequalities are satisfied. When, for example, the flow passage width W is 3 mm, the wall thickness t is preferably set to a value in the range of 0.5 to 1.95 mm. Corners including some of the sides of the housing 22 that are positioned around the gas inlet 24a (sides 22e, 22f, and 22g that are respectively opposite to the left, right, and bottom sides of the gas inlet 24a in FIGS. 2 and 3) have a radius of curvature that is preferably 1.0 mm or less, more preferably 0.1 mm or less.

One electric-charge-generating unit 30 is provided on each of the pair of left and right flow passage walls 22c and 22d so that electric charges are generated near the gas inlet 24a in the gas flow passage 24. Although the electric-charge-generating unit 30 provided on the flow passage wall 22c will be described for convenience of description, the electric-charge-generating unit 30 provided on the flow passage wall 22d is similar to the electric-charge-generating unit 30 provided on the flow passage wall 22c. The electric-charge-generating unit 30 includes a discharge electrode 32 and two ground electrodes 34 and 34. The discharge electrode 32 is provided to extend along an inner surface of the flow passage wall 22c, and has a rectangular shape with small projections along the periphery thereof, as illustrated in FIG. 4. The two ground electrodes 34 and 34 are rectangular electrodes, and are embedded in the flow passage wall 22c such that the ground electrodes 34 and 34 are separated from each other and parallel to the discharge electrode 32. The electric-charge-generating unit 30 is configured such that a gaseous discharge occurs due to a potential difference between the discharge electrode 32 and the two ground electrodes 34 and 34 when a high-frequency high voltage (for example, a pulse voltage) from a discharge power supply 36 (component of the accessory unit 80) is applied across the discharge electrode 32 and the two ground electrodes 34 and 34. A portion of the housing 22 that is disposed between the discharge electrode 32 and the ground electrodes 34 and 34 serves the function of a dielectric layer. When the gaseous discharge occurs, gas around the discharge electrode 32 is ionized and positive electric charges 28 are generated. The ground electrodes 34 and 34 are grounded in this example.

When the particles 26 contained in the gas enter the gas flow passage 24 through the gas inlet 24a and pass by the electric-charge-generating units 30, the electric charges 28 generated due to the gaseous discharge caused by the electric-charge-generating units 30 adhere to the particles 26, so that the particles 26 are changed into charged particles P. Then, the charged particles P move rearward. Among the generated electric charges 28, the electric charges 28 that have not adhered to the particles 26 simply move rearward.

The excess-electric-charge-removing unit 40 is disposed downstream of the electric-charge-generating units 30 and upstream of the collecting unit 50. The excess-electric-charge-removing unit 40 includes an application electrode 42 and a clearing electrode 44. The application electrode 42 is provided to extend along an inner surface of the right flow passage wall 22d and is exposed to the inside of the gas flow passage 24. The clearing electrode 44 is provided to extend along an inner surface of the left flow passage wall 22c and is exposed to the inside of the gas flow passage 24. The application electrode 42 and the clearing electrode 44 are positioned to face each other. The application electrode 42 is an electrode that receives a voltage V2 (positive potential) that is lower by about one order of magnitude than a voltage V1, which will be described below, from a clearing power supply 46 (component of the accessory unit 80). The clearing electrode 44 is an electrode that is grounded. Accordingly, a weak electric field is generated between the application electrode 42 and the clearing electrode 44 of the excess-electric-charge-removing unit 40. Therefore, among the electric charges 28 generated by the electric-charge-generating units 30, the excess electric charges 28 that have not adhered to the particles 26 are attracted to and collected by the clearing electrode 44 due to the weak electric field, and are discharged to the ground. Thus, the excess-electric-charge-removing unit 40 prevents the excess electric charges 28 from being collected by a collecting electrode 54 of the collecting unit 50 and being used to count the particles 26.

The collecting unit 50 is disposed downstream of the electric-charge-generating units 30 and the excess-electric-charge-removing unit 40 along the gas flow passage 24. The collecting unit 50, which collects the charged particles P, includes an electric-field-generating electrode 52 and the collecting electrode 54. The electric-field-generating electrode 52 is provided to extend along the inner surface of the right flow passage wall 22d and is exposed to the inside of the gas flow passage 24. The collecting electrode 54 is provided to extend along the inner surface of the left flow passage wall 22c and is exposed to the inside of the gas flow passage 24. The electric-field-generating electrode 52 and the collecting electrode 54 are positioned to face each other. The electric-field-generating electrode 52 is an electrode that receives the voltage V1 (positive potential), which is higher than the voltage V2 applied to the application electrode 42, from a collecting power supply 56 (component of the accessory unit 80). The collecting electrode 54 is an electrode that is grounded through an ammeter 62. Accordingly, a relatively strong electric field is generated between the electric-field-generating electrode 52 and the collecting electrode 54 of the collecting unit 50. Therefore, the charged particles P that flow through the gas flow passage 24 are attracted to and collected by the collecting electrode 54 due to the relatively strong electric field.

The sizes of the electrodes 42 and 44 of the excess-electric-charge-removing unit 40, the intensity of the electric field generated between the electrodes 42 and 44, the sizes of the electrodes 52 and 54 of the collecting unit 50, and the intensity of the electric field generated between the electrodes 52 and 54 are set so that the charged particles P are not collected by the clearing electrode 44 but are collected by the collecting electrode 54 and that the electric charges 28 that have not adhered to the particles 26 are removed by the clearing electrode 44. These settings are easily possible because, in general, the electrical mobility of the electric charges 28 is ten or more times greater than the electrical mobility of the charged particles P, and the electric charges 28 can be collected by an electric field with an intensity lower by one or more order of magnitude than that of an electric field for collecting the charged particles P. A plurality of pairs of electrodes, each pair including the electric-field-generating electrode 52 and the collecting electrode 54, may be provided.

The number detection unit 60 is a component of the accessory unit 80, and includes the ammeter 62 and a number measuring device 64. The ammeter 62 has one terminal connected to the collecting electrode 54, and another terminal connected to the ground. The ammeter 62 measures a current based on the electric charges 28 on the charged particles P collected by the collecting electrode 54. The number measuring device 64 calculates the number of particles 26 based on the current measured by the ammeter 62.

The heater electrode 72 is embedded in the housing 22. The heater electrode 72 is a strip-shaped heating element formed in a zigzag pattern (see FIG. 6). The heater electrode 72 is connected to a power feeding device (not shown), and generates heat when electricity is supplied thereto from the power feeding device. The heater electrode 72 heats the housing 22 and the electrodes including the clearing electrode 44 and the collecting electrode 54.

The structure of the particle detection element 20 will be further described with reference to the exploded perspective view of FIG. 6. The particle detection element 20 includes seven sheets S1 to S7. The sheets S1 to S7 are each made of the same material as the housing 22. For convenience of description, the sheets S1 to S7 are referred to as the first sheet S1, the second sheet S2, and so on from left to right, and right and left surfaces of each of the sheets S1 to S7 are respectively referred to as front and rear surfaces. The thicknesses of the sheets S1 to S7 may be set as appropriate. For example, the sheets S1 to S7 may have either the same thickness or different thicknesses.

The first sheet S1 has the heater electrode 72 on the front surface thereof. One and the other ends of the heater electrode 72 are disposed on an upper portion of the front surface of the first sheet S1, and are connected, via through-holes in the first sheet S1, to heater electrode terminals 75 and 75 provided on an upper portion of the rear surface of the first sheet S1.

The second sheet S2 has the ground electrodes 34 and 34 on the front surface thereof. The ground electrodes 34 and 34 are connected to a single wiring line. An end portion of the wiring line is disposed on an upper portion of the front surface of the second sheet S2, and is connected to an ground electrode terminal 35 provided on the upper portion of the rear surface of the first sheet S1 through through-holes in the second sheet S2 and the first sheet S1. A wiring line 44a for the clearing electrode 44 and a wiring line 54a for the collecting electrode 54 are provided to extend in the up-down direction on the front surface of the second sheet S2. The wiring lines 44a and 54a are respectively connected, at the top ends thereof, to a clearing electrode terminal 45 and a collecting electrode terminal 55 provided on the upper portion of the rear surface of the first sheet S1 through through-holes in the second sheet S2 and the first sheet S1.

The third sheet S3 has the discharge electrode 32, the clearing electrode 44, and the collecting electrode 54 on the front surface thereof. The clearing electrode 44 is connected to the wiring line 44a on the second sheet S2 through a through-hole in the third sheet S3, and is connected to the clearing electrode terminal 45 through the wiring line 44a. The collecting electrode 54 is connected to the wiring line 54a on the second sheet S2 through a through-hole in the third sheet S3, and is connected to the collecting electrode terminal 55 through the wiring line 54a.

The fourth sheet S4 has the gas flow passage 24, that is, a rectangular-cuboid-shaped space, near the bottom end thereof.

The fifth sheet S5 has the discharge electrode 32, the application electrode 42, and the electric-field-generating electrode 52 on the rear surface thereof.

The sixth sheet S6 has the ground electrodes 34 and 34 on the rear surface thereof. The ground electrodes 34 and 34 are connected to a single wiring line. An end portion of the wiring line is disposed on an upper portion of the rear surface of the sixth sheet S6, and is connected to the wiring line for the ground electrodes 34 on the second sheet S2 through through-holes in the third to fifth sheets S3 to S5. Accordingly, the ground electrodes 34 and 34 provided on the sixth sheet S6 are also connected to the ground electrode terminal 35 provided on the upper portion of the rear surface of the first sheet S1.

The seventh sheet S7 has a wiring line 32a for the discharge electrodes 32, a wiring line 42a for the application electrode 42, and a wiring line 52a for the electric-field-generating electrode 52, which extend in the up-down direction, on the rear surface thereof. The bottom end of the wiring line 32a is connected to the discharge electrodes 32 provided on the third and fifth sheets S3 and S5 through through-holes in the fourth to sixth sheet S4 to S6. The bottom end of the wiring line 42a is connected to the application electrode 42 provided on the rear surface of the fifth sheet S5 through through-holes in the fifth and sixth sheets S5 and S6. The bottom end of the wiring line 52a is connected to the electric-field-generating electrode 52 provided on the rear surface of the fifth sheet S5 through through-holes in the fifth and sixth sheets S5 and S6. The wiring lines 32a, 42a, and 52a are respectively connected, at the top ends thereof, to a discharge electrode terminal 33, an application electrode terminal 43, and an electric-field-generating electrode terminal 53 provided on an upper portion of the front surface of the seventh sheet S7 through through-holes in the seventh sheet S7.

An example of a method for manufacturing the particle detector 10 will now be described. The particle detection element 20 can be manufactured by using a plurality of ceramic green sheets. More specifically, each of the ceramic green sheets is processed to form cuts, through-holes, and grooves therein and to form electrodes and wiring patterns by screen printing as necessary. After that, the ceramic green sheets are stacked together and fired. The cuts, through-holes, and grooves may be filled with a material (for example, an organic material) that can be incinerated in the firing process. Thus, the particle detection element 20 is obtained. Next, the discharge electrode terminal 33, the application electrode terminal 43, and the electric-field-generating electrode terminal 53 of the particle detection element 20 are respectively connected to the discharge power supply 36, the clearing power supply 46, and the collecting power supply 56 of the accessory unit 80. In addition, the ground electrode terminal 35 and the clearing electrode terminal 45 on the particle detection element 20 are grounded, and the collecting electrode terminal 55 is connected to the number measuring device 64 through the ammeter 62. In addition, the heater electrode terminals 75 and 75 are connected to the power feeding device (not shown). Thus, the particle detector 10 can be manufactured.

An example of how the particle detector 10 is used will now be described. When the particles 26 contained in exhaust gas of an automobile are to be detected, the particle detection element 20 is attached to the exhaust pipe 12 of the engine, as described above (see FIG. 1).

As illustrated in FIG. 5, the particles 26 contained in the exhaust gas that has been introduced into the housing 22 through the gas inlet 24a are changed into the charged particles P when the electric charges 28 (positive electric charges in this example) generated due to a discharge caused by the electric-charge-generating units 30 adhere to the particles 26. The charged particles P pass through the excess-electric-charge-removing unit 40, which generates a weak electric field and includes the clearing electrode 44 that is shorter than the collecting electrode 54, and reach the collecting unit 50. The electric charges 28 that have not adhered to the particles 26 are attracted to the clearing electrode 44 of the excess-electric-charge-removing unit 40 even in the weak electric field, and are discharged to GND through the clearing electrode 44. Accordingly, most of the unnecessary electric charges 28 that have not adhered to the particles 26 do not reach the collecting unit 50.

The charged particles P that have reached the collecting unit 50 are collected by the collecting electrode 54 due to the collecting electric field generated by the electric-field-generating electrode 52. The current based on the electric charges 28 on the charged particles P collected by the collecting electrode 54 is measured by the ammeter 62, and the number measuring device 64 calculates the number of particles 26 based on the current. The relationship between the current 1 and the amount of electric charges q is 1=dq/(dt), q=∫1dt. The number measuring device 64 integrates (accumulates) the current value for a predetermined period to determine an integral value (amount of accumulated electric charges), divides the amount of accumulated electric charges by the elementary charge to determine the total number of electric charges (number of collected electric charges), and divides the number of collected electric charges by the average number of electric charges that adhere to a single particle 26 (average number of electric charges) to determine the number Nt of particles 26 collected by the collecting electrode 54 (see Equation (1) given below). The number measuring device 64 determines this number Nt as the number of particles 26 in the exhaust gas.

Nt=(amount of accumulated electric charges)/{(elementary charge)×(average number of electric charges)} (1)

When the particle detection element 20 is used, a large number of particles 26 and other substances may accumulate on the collecting electrode 54 over time. In such a case, the collecting electrode 54 may become unable to collect additional charged particles P. Therefore, the collecting electrode 54 is heated by the heater electrode 72 periodically or when the amount of accumulated substances reaches a predetermined amount. Accordingly, the substances that have accumulated on the collecting electrode 54 are incinerated and the electrode surface of the collecting electrode 54 is refreshed. In addition, the particles 26 that have adhered to the inner peripheral surface of the housing 22 can also be incinerated by using the heater electrode 72.

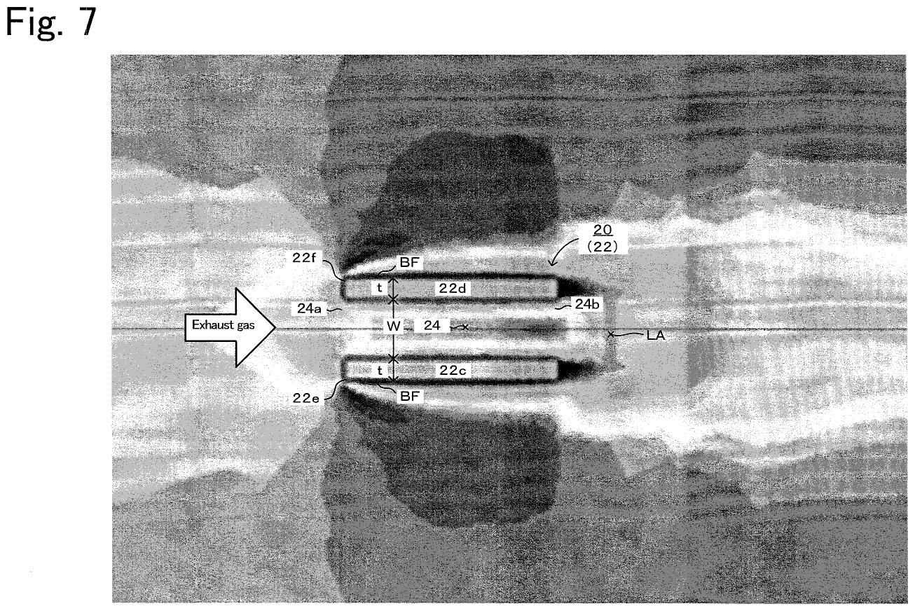

The gas flow passage 24 is a rectangular-cuboid-shaped space that extends continuously from the gas inlet 24a having a rectangular shape to the gas outlet 24b having the same shape as the gas inlet 24a. When the exhaust gas is caused to pass through the gas flow passage 24, the flow velocity distribution shown in FIG. 7 is obtained. FIG. 7 shows the flow velocity distribution on a sectional view of the particle detection element 20 (corresponding to a sectional view of FIG. 2 taken along line B-B) when the particle detection element 20 is placed in a flow of the exhaust gas. FIG. 7 is based on a color diagram showing the flow velocity distribution such that the flow velocity decreases in the order of red, orange, yellow, green, blue, indigo, and purple regions. FIG. 7 is a grayscale diagram into which the color diagram is converted. As illustrated in FIG. 7, a low-flow-velocity region LA in which the exhaust gas flows at a flow velocity lower than the flow velocity at which the exhaust gas passes through the gas flow passage 24 is generated in a region downstream of the gas outlet 24b. The charged particles P that have not been collected by the collecting electrode 54 flow out of the gas outlet 24b and reach the low-flow-velocity region LA. The charged particles P that have reached the low-flow-velocity region LA serve to push back the subsequent charged particles P toward the gas flow passage 24 by electric repulsive force when the subsequent charged particles P are not collected by the collecting electrode 54 and flow out of the gas outlet 24b. As a result, the collection rate at which the collecting electrode 54 collects the charged particles P is increased.

The low-flow-velocity region LA shown in FIG. 7 satisfies R≤0.57 when R is a flow velocity ratio determined as (flow velocity of the exhaust gas in the low-flow-velocity region LA)/(maximum flow velocity of the exhaust gas that passes through the gas flow passage 24). Whether or not the low-flow-velocity region LA that satisfies R≤0.57 exists can be easily determined by referring to the color diagram showing the flow velocity distribution on which FIG. 7 is based. FIG. 7 shows that the low-flow-velocity region LA is formed to cover the gas outlet 24b. Accordingly, the charged particles P that have reached the low-flow-velocity region LA easily push back the subsequent charged particles P toward the gas flow passage 24 when the subsequent charged particles P flow out of the gas outlet 24b as described above, and the collection rate of the charged particles P is further increased.

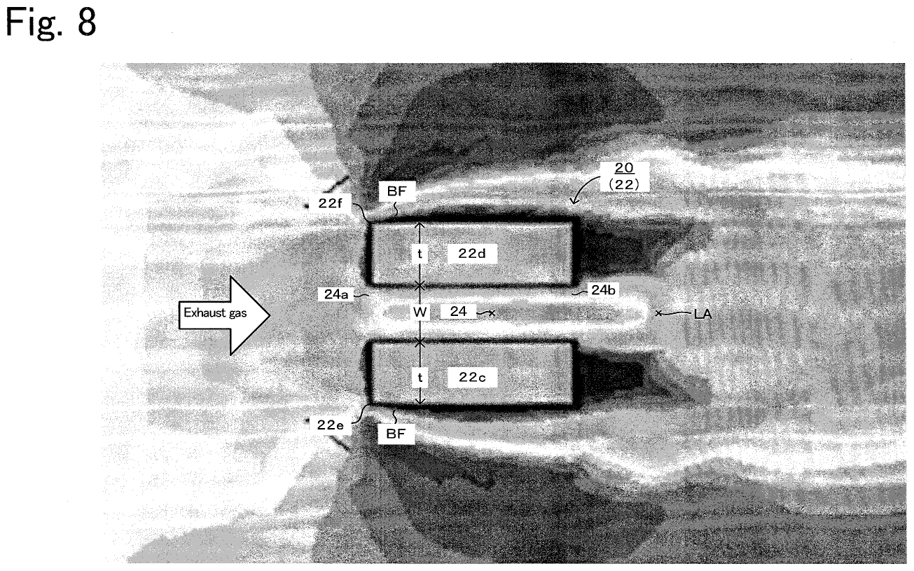

The wall thickness t of the flow passage walls 22c and 22d illustrated in FIG. 7 satisfy (wall thickness t of the flow passage walls)/(flow passage width W)≤0.65. More specifically, in FIG. 7, t=1 mm and W=3 mm. In this case, the low-flow-velocity region LA is reliably formed to cover the gas outlet 24b, and the flow velocity of the exhaust gas in the low-flow-velocity region LA is sufficiently low so that (flow velocity ratio R)≤0.31 is satisfied. Accordingly, the charged particles P that have reached the low-flow-velocity region LA more easily push back the subsequent charged particles P toward the gas flow passage 24 when the subsequent charged particles P flow out of the gas outlet 24b as described above, and the collection rate of the charged particles P is further increased. Such an effect can be obtained when t/W≤0.65 is satisfied. Even when the wall thickness t of the flow passage walls 22c and 22d does not satisfy t/W≤0.65, the effect of increasing the collection rate of the charged particles P can be obtained. For example, even when the wall thickness t is equal to the flow passage width W as illustrated in FIG. 8 (t=W=3 mm in FIG. 8), the low-flow-velocity region LA is generated in a region downstream of the gas outlet 24b, and is formed to cover the gas outlet 24b, although not as clearly as in FIG. 7. Accordingly, the effect of increasing the collection rate of the charged particles P can be obtained. Although the low-flow-velocity region LA in FIG. 8 satisfies (flow velocity ratio R)≤0.57, (flow velocity ratio R)≤0.31 is not satisfied. Therefore, the effect of increasing the collection rate of the charged articles P is greater in FIG. 7 than in FIG. 8. The wall thickness t and the flow passage width W do not include the thickness of the electrodes 32, 42, 44, 52, and 54 (generally several tens of micrometers).

The radius of curvature of the corners including the sides 22e to 22g of the housing 22 that are positioned around the gas inlet 24a (see FIG. 3) is preferably 1.0 mm or less (in particular, 0.3 mm or less). In this case, as illustrated in FIG. 7, the exhaust gas that has not entered the gas flow passage 24 through the gas inlet 24a comes into contact with the corners, and then flows at a low velocity in regions closer to the housing 22 than are separation surfaces BF, which extend obliquely rearward from the outer surfaces of the housing 22, and at a high velocity in regions farther from the housing 22 than are the separation surfaces BF. It is generally known that the efficiency of heat exchange between low-velocity gas and a solid is lower than the efficiency of heat exchange between high-velocity gas and a solid. Therefore, the heat exchange between the housing 22 and the exhaust gas is reduced, and a temperature change in the housing 22 is reduced accordingly. As a result, the accuracy of measurement of the number Nt of particles is increased. More specifically, the number Nt of particles 26 is a function of the average number of electric charges, as described above, and the average number of electric charges is known to be a function of temperature. Therefore, when the temperature change in the housing 22 is reduced and the average number of electric charges is stabilized, the accuracy of measurement of the number Nt is increased. When the radius of curvature of the corners including the sides 22e to 22g is greater than 1.0 mm, the separation surfaces BF are not formed and the gas flows along the outer surfaces of the housing 22 at a high velocity. Accordingly, the temperature change in the housing 22 is not reduced. The effect of the structure in which the radius of curvature of the corners including the sides 22e to 22g is 1.0 mm or less can be obtained irrespective of the relationship between the wall thickness t and the flow passage width W. For example, this effect can also be obtained in the case of FIG. 8. However, the above structure is significantly advantageous when (wall thickness t of the flow passage walls)/(flow passage width W)≤0.65 is satisfied. This is because, in this case, the flow passage walls 22c and 22d have a small heat capacity and are therefore easily affected by the heat exchange with the exhaust gas. The separation surfaces BF are formed also when the radius of curvature is 0 mm. However, when the corners are too sharp, the corners that project are easily chipped and the shape thereof may become non-uniform due to the chipped surfaces. The corners having such a non-uniform shape may disturb the flow, in which case stable separation surfaces cannot be easily formed. To prevent this, the radius of curvature is preferably greater than or equal to 0.01 mm.

According to the above-described particle detector 10, the charged particles P that have not been collected by the collecting electrode 54 flow out of the gas outlet 24b and reach the low-flow-velocity region LA. The charged particles P that have reached the low-flow-velocity region LA serve to push back the subsequent charged particles P toward the gas flow passage 24 by electric repulsive force when the subsequent charged particles P are not collected by the collecting electrode 54 and flow out of the gas outlet 24b. As a result, the collection rate at which the collecting electrode 54 collects the charged particles P is increased. When the voltage V1 is increased to increase the collecting performance of the particle detector 10, there are risks of dielectric breakdown in the gas flow passage 24 and short-circuiting between the wiring lines. Therefore, it is highly effective to increase the collection rate without changing the voltage V1.

The particle detector 10 is preferably configured such that (flow velocity ratio R)≤0.57 is satisfied and that the low-flow-velocity region LA is formed to cover the gas outlet 24b. In this case, the collection rate at which the collecting electrode 54 collects the charged particles P is further increased.

In addition, t/W≤0.65 is preferably satisfied. In this case, the low-flow-velocity region LA is reliably formed to cover the gas outlet 24b, and the flow velocity of the exhaust gas in the low-flow-velocity region LA is sufficiently low so that (flow velocity ratio R)≤0.31 is satisfied. Therefore, the collection rate at which the collecting electrode 54 collects the charged particles P is further increased. To ensure sufficient strength of the flow passage walls 22c and 22d, 0.17≤t/W is preferably satisfied.

In addition, the radius of curvature of the corners including the sides 22e to 22g of the housing 22 that are positioned around the gas inlet 24a is preferably 1.0 mm or less. In this case, the heat exchange between the outer surfaces of the housing 22 and the exhaust gas is reduced, and the temperature change in the housing 22 is reduced accordingly. As a result, the accuracy of measurement of the number Nt of particles is increased.

In addition, the housing 22, which is an elongated body, has the gas flow passage 24 at the bottom end thereof that is disposed in the exhaust pipe 12, and has the electrode terminals 33, 35, 43, 45, 53, 55, and 75 at the top end thereof that is disposed outside the exhaust pipe 12. Therefore, the electrode terminals 33, 35, 43, 45, 53, 55, and 75 are not easily affected by the high-temperature exhaust gas that flows through the exhaust pipe 12, and can be connected to external wires with a joining material having a relatively low heat resistance, such as solder.

The collecting electrode 54 collects the charged particles P by using an electric field. Therefore, the charged particles P can be efficiently collected on the collecting electrode 54.

In addition, since the heater electrode 72 is embedded in the housing 22, the temperature of the housing 22 can be controlled by using the heater electrode 72. In addition, the particles 26 that adhere to the collecting electrode 54 and other components when the particle detection element 20 is used can be heated by the heater electrode 72 and incinerated to refresh the collecting electrode 54 and other components.

In addition, the particle detection element 20 includes the clearing electrode 44 that is disposed upstream of the collecting electrode 54 in the direction of the gas flow in the housing 22. Therefore, the electric charges 28 that have not adhered to the particles 26 (excess electric charges) are removed by the clearing electrode 44 before being collected by the collecting electrode 54. Thus, the number of particles can be prevented from being affected by the excess electric charges.

It is needless to say that the present invention is not limited to the above-described embodiment in any way, and may be practiced in various modes as long as the modes belong to the technical scope of the present invention.

For example, in the above-described embodiment, the flow passage walls 22c and 22d of the gas flow passage 24 have the wall thickness t. However, the flow passage wall 22c may have a wall thickness t1, and the flow passage wall 22d may have a wall thickness t2 (≠t1). In this case, preferably, (wall thickness t1 of the flow passage wall)/(flow passage width W)≤0.65 and (wall thickness t2 of the flow passage wall)/(flow passage width W)≤0.65 are both satisfied.

In the above-described embodiment, two or more gas flow passages 24 may be provided next to each other in the housing 22. In such a case, for example, the intensity of the electric field generated by the collecting electrode 54 may be changed for each gas flow passage 24 so that the particle diameter distribution of the particles 26 that are collected can be changed for each gas flow passage 24.

In the above-described embodiment, the particle detection element 20 may be configured such that the low-flow-velocity region LA is not generated and that the radius of curvature of the corners including the sides 22e to 22g of the housing 22 that are positioned around the gas inlet 24a is 1.0 mm or less (in particular, 0.3 mm or less). In such a case, the effect of the low-flow-velocity region LA is not obtained, but the effect of the corners can be obtained. More specifically, the heat exchange between the outer surfaces of the housing 22 and the exhaust gas is reduced so that the temperature change in the housing 22 is reduced, and the accuracy of measurement of the number Nt of particles is increased.

In the above-described embodiment, each electric-charge-generating unit 30 includes the discharge electrode 32 that extends along the inner surface of the gas flow passage 24 and two ground electrodes 34 and 34 that are embedded in the housing 22. However, each electric-charge-generating unit 30 may have any structure as long as electric charges can be generated due to a gaseous discharge. For example, the ground electrodes 34 and 34 may be provided to extend along the inner surface of the gas flow passage 24 instead of being embedded in the walls around the gas flow passage 24. Alternatively, as described in PTL 1, each electric-charge-generating unit may include a needle electrode and a counter electrode.

Although the electric-field-generating electrode 52 is exposed in the gas flow passage 24 in the above-described embodiment, the electric-field-generating electrode 52 may instead be embedded in the housing 22. In addition, the electric-field-generating electrode 52 may be replaced with a pair of electric-field-generating electrodes provided in the housing 22 such that the collecting electrode 54 is disposed therebetween in the up-down direction, and the charged particles P may be moved toward the collecting electrode 54 in an electric field generated by applying a voltage between the pair of electric-field-generating electrodes. This also applies to the application electrode 42.

In the above-described embodiment, the voltage V1 is applied to the electric-field-generating electrode 52. However, even when no voltage is applied and no electric field is generated by the electric-field-generating electrode 52, when the flow passage width W is set to a small value (for example, 0.01 mm or greater and less than 0.2 mm), the charged particles P having relatively small particle diameters and undergoing rapid Brownian motion reach the collecting electrode 54. Accordingly, the charged particles P can be collected by the collecting electrode 54. In this case, it is not necessary that the particle detection element 20 include the electric-field-generating electrode 52.

In the above-described embodiment, the particle detector 10 is attached to the exhaust pipe 12 of an engine. However, an object to which the particle detector 10 is attached is not particularly limited to the exhaust pipe 12 of an engine, and may instead be any pipe as long as gas containing particles pass therethrough.

Although the particle detection element 20 determines the number of particles in the above-described embodiment, the particle detection element 20 may instead determine the mass or surface area of the particles. The mass of the particles can be determined by multiplying the number of particles by the average mass of the particles. Alternatively, a map showing the relationship between the amount of accumulated electric charges and the mass of the collected particles may be stored in a storage device in advance, and the mass of the particles may be determined based on the amount of accumulated electric charges by referring to this map. The surface area of the particles may be determined by a method similar to the method for determining the mass of the particles.

What is claimed is:

1. A particle detection element used to detect particles in gas, the particle detection element comprising:
a housing having a gas flow passage through which the gas passes;
an electric-charge-generating unit that supplies electric charges generated due to a discharge to the particles in the gas introduced into the housing, thereby changing the particles into charged particles; and
a collecting electrode disposed in the housing at a location downstream of the electric-charge-generating unit along a flow of the gas, the collecting electrode collecting the charged particles,
wherein the gas flow passage is a rectangular-cuboid-shaped space that extends continuously from a gas inlet having a rectangular shape to a gas outlet having same shape as the shape of the gas inlet, and when the particle detection element is disposed in the flow of the gas so that the gas passes through the gas flow passage, a low-flow-velocity region in which the gas flows at a flow velocity lower than a flow velocity at which the gas passes through the gas flow passage is generated in a region downstream of the gas outlet.

2. The particle detection element according to claim 1, wherein (flow velocity of the gas in the low-flow-velocity region)/(maximum flow velocity of the gas that passes through the gas flow passage)≤0.57 is satisfied.

3. The particle detection element according to claim 1, wherein the low-flow-velocity region is formed to cover the gas outlet.

4. The particle detection element according to claim 1, wherein the housing includes a pair of flow passage walls that define the gas flow passage, and when a distance between the pair of flow passage walls is defined as a flow passage width of the gas flow passage, (wall thickness of the flow passage walls)/(flow passage width)≤0.65 is satisfied.

5. The particle detection element according to claim 1, wherein a corner including a side of the housing that is positioned around the gas inlet has a radius of curvature of 1.0 mm or less.

6. The particle detection element according to claim 1, wherein the housing is an elongated body that extends in a longitudinal direction that crosses an axial direction of the gas flow passage, one end of the elongated body in the longitudinal direction having the gas flow passage and being disposed in a pipe through which the gas flows, other end of the elongated body in the longitudinal direction having at least a terminal of the electric-charge-generating unit and a terminal of the collecting electrode and being disposed outside the pipe.

7. A particle detector comprising:
particle detection element according to claim 1; and
a detection unit that detects the particles based on a physical quantity that varies depending on the charged particles collected by the collecting electrode.
